(19) United States
(12) Patent Application Publication
(10) Pub. No.: US 2010/0001146 A1
(43) Pub. Date: Jan. 7, 2010

(54) Stand Device

(76) Inventor: Yaniv Shimshon, Petah Tikva (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/186,538

(22) Filed: Aug. 6, 2008

(30) Foreign Application Priority Data
Jul. 2, 2008 (GB) GB0715161.6
Jul. 2, 2008 (IL) 192578

(51) Int. Cl. F16M 11/04; F16M 11/26

(52) U.S. Cl. 248/157; 248/176.1; 248/176.3

(57) ABSTRACT

A stand device comprises clips for removably attaching to a student chair or to a tabletop, holding device for a calculator or PDA, and a holding arm connected at one end to the clips and at its other end to the PDA holding device. The holding arm in the stand device may be adjustable. The holding arm may be adjustable using clicks or a telescopic structure.

### CROSS-REFERENCE TO RELATED APPLICATIONS

The present invention is related to, and claims priority from, the patent application GB0715161.6 filed in UK on 6 Aug. 2007 and the patent application No. 192578 filed in Israel on 2 Jul. 2008, both filed by the present inventor and entitled “Stand device”.

### BACKGROUND OF THE INVENTION

1. Field of the Invention

The invention relates to a dismountable personal stand for a PDA or calculator with additional storage for pens, pencils and other accessories.

2. Description of Related Art

A student chair has only a limited work space for a notebook or book.

The student, however, may need other things, such as a calculator, a personal digital assistant (PDA), a pen or other writing utensils, etc.

Even if the student has a small table available, the works space is limited.

Thus, the student has to keep all the above in a briefcase, usually on the floor. It may be inconvenient and time consuming to access the briefcase every time it is required.

Moreover, such activities are disruptive and counter-productive to the student's task, that is to be focused on his/her study.

### BRIEF SUMMARY OF THE INVENTION

According to the present invention, a stand device may be removably attached to a student chair or to a tabletop. Thus, the student may take it with him anywhere, and attach it to a chair as the need be.

According to another aspect of the invention, the stand device take only a minimal space of the work space. The stand itself is elevated (in the air) thus increasing the work space available to the student.

Furthermore, the additional work space is of higher quality, since its location and orientation can be adjusted using an adjustable arm, to better adapt to the student's physique and work habits.

According to yet another aspect of the invention, the device can also include a pen/pencil case.

Furthermore, magnet may hold pens or pencils on the outside of the case, for easy access. For this purpose, a ferromagnetic ring or other part may be attached to each pen or pencil.

### BRIEF DESCRIPTION OF THE SEVERAL VIEWS OF THE DRAWING

An example of a preferred embodiment of the invention will now be described by way of example and with reference to the accompanying drawings in which:

FIG. 1 illustrates, in perspective, a stand device with pencils attachable thereon

FIG. 2 details a side view of the stand device holding a PDA and with a pencil attached thereto

FIG. 3 illustrates, in perspective, a stand device with a pen/pencils case

FIGS. 4 and 5 detail adjustable holding arms for the stand device.

FIG. 6 illustrates, in perspective, another embodiment of a stand device with pencils attachable thereon

### DETAILED DESCRIPTION OF THE INVENTION

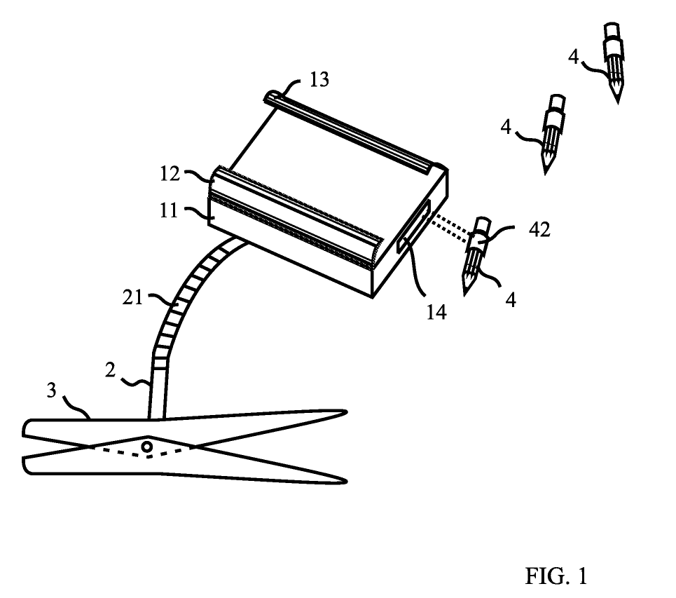

Referring to the drawings, in a preferred embodiment as illustrated in FIG. 1, a pen/pencils case 11 having PDA holding means 12, 13 on its upper side can be attached to a student's chair by means of a holding arm 2 and clips means 3.

The junction between case 11 and arm 2, and/or the junction between clips 3 and arm 2, can be rotatable, so as to adjust the location and orientation of the case 11 to adapt to student's personal preferences.

Furthermore, a magnet 14 mounted on the case 11 can be used for holding pens or pencils 4. For this purpose, a ferromagnetic ring 42 is mounted on each pencil or pen, or another shape of a ferromagnetic part may be attached thereon.

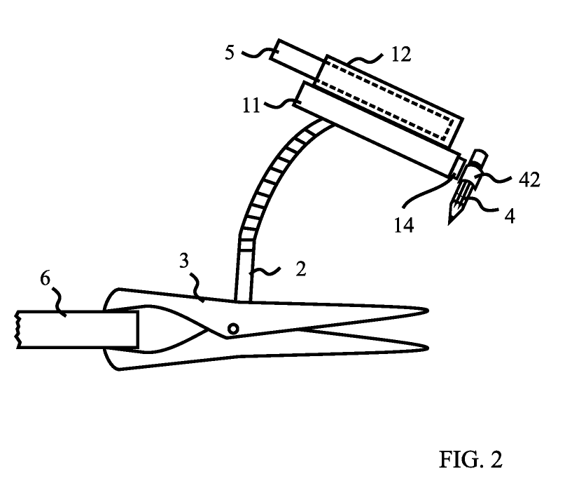

FIG. 2 details a side view of the stand device holding a PDA 5 and with a pencil 4 attached thereto.

The PDA or calculator 5 is held by PDA holding means 12, located on the pen/pencils case 11.

The pen or pencil 4 is attached to case 11 using the magnet 14, by means of the ferromagnetic ring 42 on the pen.

The holding arm 2 is attached to the student chair or tabletop 6 by means of the clips means 3.

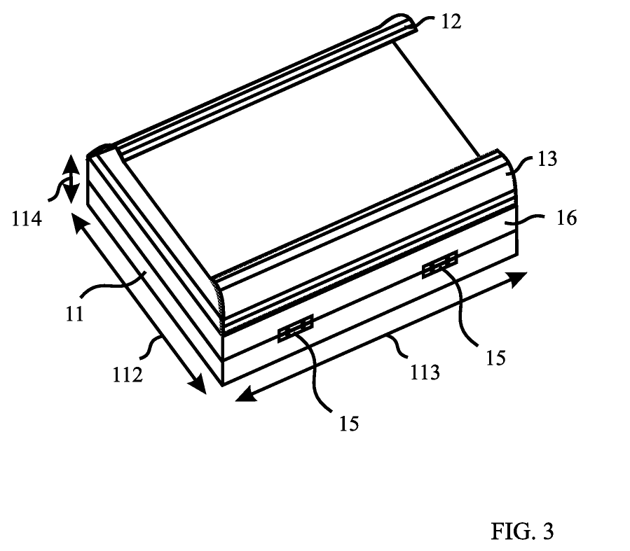

FIG. 3 illustrates, in perspective, a stand device with a pen/pencils case 11. In a preferred embodiment, its general dimensions may be as follows (these are approximate dimensions only):
length 113 of 16.5 centimeters (cm)
width 112 of 8.5 cm
height 114 of 3 cm.

The pen/pencil case top 16 is attached to case 11 using hinges 15 (two units in this embodiment, may use more if desired).

Holding means 12, 13 may be elastic to hold calculators of various dimensions. Alternately, other adjusting means may be used to accommodate various PDAs or calculators.

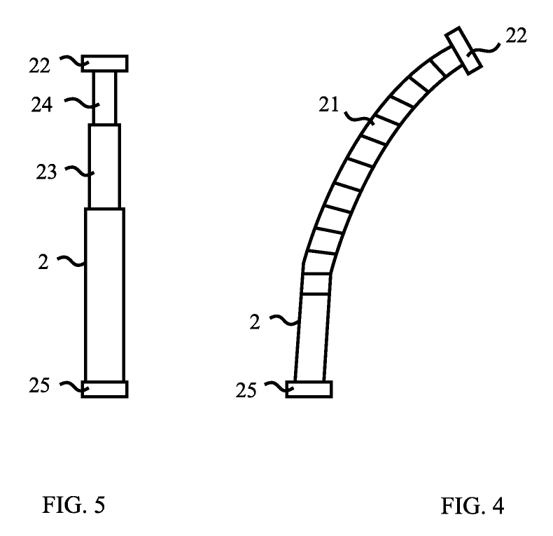

FIGS. 4 and 5 detail adjustable holding arms for the stand device.

The holding arm 2 for the stand device may include, in one embodiment, an adjustable part 21 using clicks (FIG. 4).

In another embodiment, holding arm 2 may include telescopic means 23, 24 (FIG. 5).

The above structure of the holding arm 2 may be used to adjust the location and angle of the case 11 and the PDA thereon for user's comfort.

Furthermore, the holding arm 2 may include an upper end 22 which attaches to the case 11, and a lower end 25 which attaches to the clips means 3.

The device may include only the pen/pencils case 11, or only the PDA holding means 12, 13 on its upper side.

In yet another embodiment, the device may include both case 11 and holding means 12, 13.

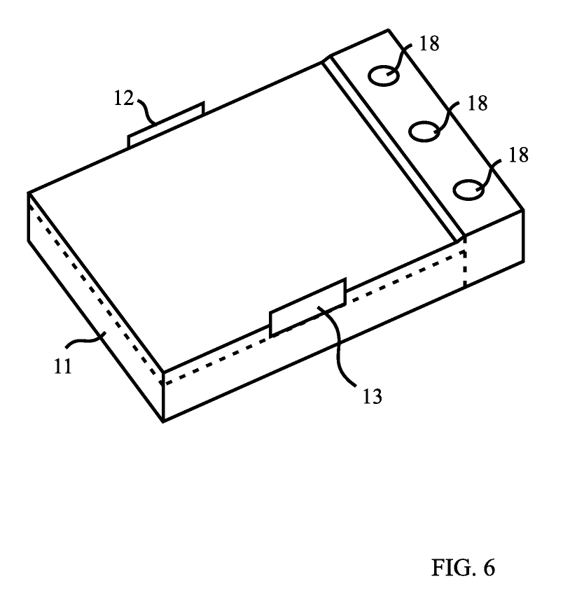

FIG. 6 illustrates, in perspective, another embodiment of a stand device with pencils and/or pens attachable thereon.

The device includes a part with holes 18 in its upper part. Pencils or pens may simply be inserted in the holes 18 to keep them in order, visible and easily available.

The part with the holes is preferably separated by a division from the pen/pencils case 11, to keep the case closed to dirt or dust.

It will be recognized that the foregoing is but one example of a device and method within the scope of the present invention, and that various modifications will occur to those skilled in the art upon reading the disclosure set forth hereinbefore.

1. A stand device comprising clips means for removably attaching to a student chair or to a tabletop, holding means for a calculator or PDA, and a holding arm connected at one end to the clips means and at its other end to the PDA holding means.

2. The stand device according to claim 1, wherein the holding arm is adjustable.

3. The stand device according to claim 2, wherein the holding arm is adjustable using clicks or a telescopic structure.

4. The stand device according to claim 1, wherein the holding arm is rotatably connected to the clips means and/or the PDA holding means.

5. The stand device according to claim 2, wherein the holding arm is rotatably connected to the clips means and/or the PDA holding means.

6. The stand device according to claim 3, wherein the holding arm is rotatably connected to the clips means and/or the PDA holding means.

7. The stand device according to claim 1, further including a pencil/pens case, wherein the case is connected to the upper end of the holding arm and the PDA holding means are mounted on the upper part of the case.

8. The stand device according to claim 2, further including a pencil/pens case, wherein the case is connected to the upper end of the holding arm and the PDA holding means are mounted on the upper part of the case.

9. The stand device according to claim 3, further including a pencil/pens case, wherein the case is connected to the upper end of the holding arm and the PDA holding means are mounted on the upper part of the case.

10. The stand device according to claim 1, further including means for holding pens or pencils thereon.

11. The stand device according to claim 2, further including means for holding pens or pencils thereon.

12. The stand device according to claim 3, further including means for holding pens or pencils thereon.

13. The stand device according to claim 10, wherein the means for holding pens or pencils include magnetic holding means.

14. The stand device according to claim 11, wherein the means for holding pens or pencils include magnetic holding means.

15. The stand device according to claim 12, wherein the means for holding pens or pencils include magnetic holding means.

16. The stand device according to claim 10, wherein the means for holding pens or pencils include holes for inserting the pens or pencils thereon.

17. The stand device according to claim 11, wherein the means for holding pens or pencils include holes for inserting the pens or pencils thereon.

18. The stand device according to claim 12, wherein the means for holding pens or pencils include holes for inserting the pens or pencils thereon.
